(19) United States
(12) Patent Application Publication
(10) Pub. No.: US 2013/0257135 A1
(43) Pub. Date: Oct. 3, 2013

(54) NON-CIRCULAR CYLINDER ASSEMBLY FOR RAISING AND LOWERING A DUMP TRUCK TAILGATE

(71) Applicant: Gregg L. Kennedy, Cleveland, OK (US)

(72) Inventor: Gregg L. Kennedy, Cleveland, OK (US)

(21) Appl. No.: 13/436,860

(22) Filed: Mar. 31, 2012

(51) Int. Cl. B60P 1/26

(52) U.S. Cl. CPC B60P 1/26
USPC 298/23 MD

(57) ABSTRACT

An apparatus includes a dump box having an open end and a tailgate supported on the dump box for movement between a closed position, wherein the tailgate closes the open rear end of the dump box, and an opened position, wherein the tailgate is spaced away from the open end of the dump box. A cylinder assembly extends between the dump box and the tailgate. The cylinder assembly includes a cylinder and a piston that is able to move relative to the cylinder for selectively moving the tailgate between the closed and opened positions. The cylinder assembly has a cross-sectional shape that is non-circular.

### BACKGROUND OF THE INVENTION

This invention relates in general to mechanisms for raising and lowering a tailgate provided on a dump box of a dump truck, trailer, or similar vehicle. In particular, this invention relates to a non-circular cylinder assembly for raising and lowering such a tailgate that is pivotably supported on the dump box.

A typical dump truck includes a dump box that is movable (usually by pivoting) between a lowered position (for storing and transporting items) and a raised position (for dumping the items out of the dump box). A typical dump box includes a floor, a pair of side walls, a front wall, and an open rear end for accomplishing this function. Frequently, the open rear end of the dump box includes a pair of upstanding corner posts that are each formed from a hollow rectangular member. A tailgate is supported on the side walls of the dump box adjacent to the open rear end for pivoting movement between a closed position (wherein the tailgate closes the open rear end of the dump box for facilitating the storing and transporting of the items therein) and an opened position (wherein the tailgate is pivoted away from the open rear end of the dump box for facilitating the dumping of the items out of the dump box).

In many instances, the tailgate is affirmatively moved between the opened and closed positions by means of a cylinder (typically a pneumatic cylinder) that extends between the dump box and the tailgate. When the cylinder is extended, the tailgate is pivoted away from the open rear end of the dump box to the opened position. When the cylinder is retracted, the tailgate is pivoted toward the open rear end of the dump box to the closed position. In this manner, the operation of the cylinder controls the movement of the tailgate between the opened and closed positions.

In the past, the cylinder has typically been provided on the dump truck in one of two locations. In a first generally vertical orientation, a cylinder has been located within either or both of the hollow upstanding corner posts provided on the open rear end of the dump box. This generally vertical orientation is desirable because it does not expand the overall width of the vehicle, which can be limited by practical considerations or by regulation. However, the internal space that is available within each of these corner posts is limited, thus limiting the size of the cylinder that can be provided within each of the corner posts (and, as a result, the amount of force that is available to move the tailgate between the opened and closed positions) is relatively limited. In a second, generally horizontal orientation, a cylinder has been located on the outside of either or both of the side walls of the dump box. This generally horizontal orientation is desirable because it is simple and inexpensive to install. However, as mentioned above, it does undesirably expand the overall width of the vehicle. Thus, it would be desirable to provide an improved mechanism for raising and lowering a tailgate provided on a dump box of a dump truck, trailer, or similar vehicle that avoids these problems.

### SUMMARY OF THE INVENTION

This invention relates in general to an improved mechanism for raising and lowering a tailgate provided on a dump box of a dump truck, trailer, or similar vehicle. The mechanism includes a dump box having an open end and a tailgate supported on the dump box for movement between a closed position, wherein the tailgate closes the open rear end of the dump box, and an opened position, wherein the tailgate is spaced away from the open end of the dump box. A cylinder assembly extends between the dump box and the tailgate. The cylinder assembly includes a cylinder and a piston that is able to move in an axial direction relative to the cylinder for selectively moving the tailgate between the closed and opened positions. The piston has a non-circular cross-sectional shape.

The invention also relates to a vehicle that includes a frame and a dump box having an open end. The dump box is supported on the frame for movement between a lowered position for storing and transporting items and a raised position for dumping the items out of the dump box. A tailgate is supported on the dump box for movement between a closed position, wherein the tailgate closes the open rear end of the dump box, and an opened position, wherein the tailgate is spaced away from the open end of the dump box. A cylinder assembly extends between the dump box and the tailgate for selectively moving the tailgate between the closed and opened positions. The cylinder assembly includes a cylinder and a piston that is able to move in an axial direction relative to the cylinder for selectively moving the tailgate between the closed and opened positions. The piston has a non-circular cross-sectional shape.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a prior art dump truck including a conventional cylinder assembly.

FIG. 2 is an enlarged perspective view of a portion of the prior art dump truck illustrated in FIG. 1.

FIG. 3 is a further enlarged perspective view, partially broken away, of a portion of the prior art dump truck illustrated in FIGS. 1 and 2.

FIG. 4 is a perspective view of a dump truck including a first embodiment of a non-circular cylinder assembly in accordance with this invention.

FIG. 5 is a further enlarged perspective view of the non-circular cylinder assembly illustrated in FIG. 4 shown in a retracted position.

FIG. 6 is a side elevational view of the non-circular cylinder assembly illustrated in FIGS. 4 and 5.

FIG. 7 is a top plan view of the non-circular cylinder assembly illustrated in FIGS. 4, 5, and 6.

FIG. 8 is a perspective view similar to FIG. 5 showing the non-circular cylinder assembly in an extended position.

FIG. 9 is perspective view similar to FIG. 8, in which a portion of the cylinder has been cut-away so that an internal piston is visible.

FIG. 10 a cross-sectional view of a portion of the non-circular cylinder assembly taken along the line 10-10 of FIG. 8.

FIG. 11 is a cross-sectional view similar to FIG. 10 showing a portion of a second embodiment of a non-circular cylinder having a rectangular cross-sectional shape.

FIG. 12 is a cross-sectional view similar to FIG. 10 showing a portion of a third embodiment of a non-circular cylinder having an oval cross-sectional shape.

### DETAILED DESCRIPTION OF THE PREFERRED EMBODIMENTS

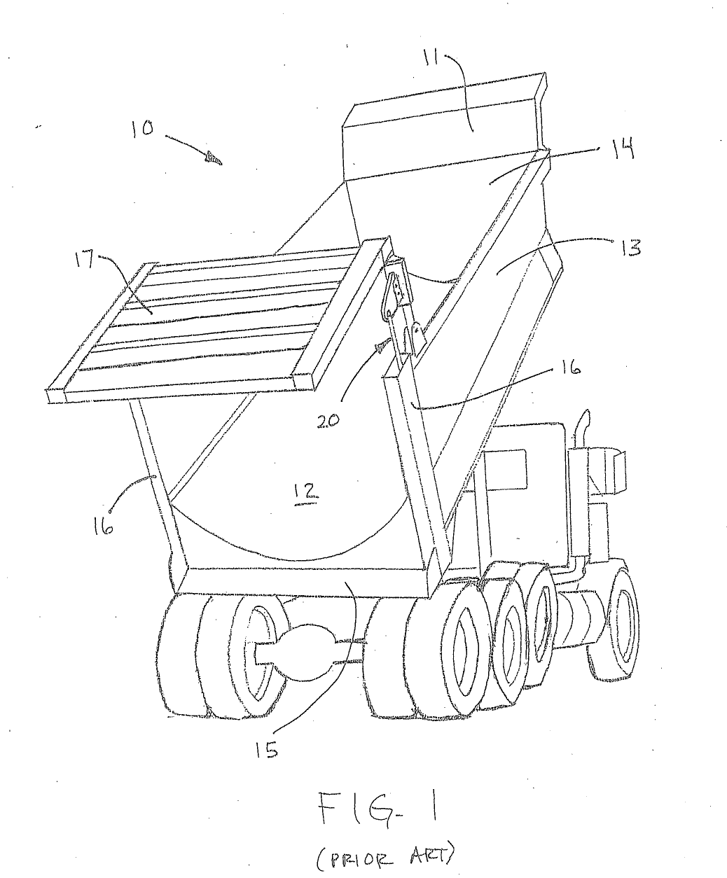

Referring now to the drawings, there is illustrated in FIG. 1 a dump truck, indicated generally at 10, including a frame that supports a prior art dump box 11 that is pivotable between a lowered position (for storing and transporting items) and a raised position (for dumping the items out of the dump box 11). The prior art dump box 11 includes a floor 12, a pair of side walls 13, a front wall 14, and an open rear end 15. The open rear end 15 of the prior art dump box 11 has a pair of upstanding corner posts 16 that are each formed from a hollow rectangular member. A tailgate 17 is supported on the side walls 13 of the prior art dump box 11 adjacent to the open rear end 15 for pivoting movement between a closed position (wherein the tailgate 17 closes the open rear end 15 of the prior art dump box 11) and an opened position (wherein the tailgate 17 is spaced away from the open rear end 15 of the prior art dump box 11, as shown in FIG. 1). The tailgate 17 is moved between the opened and closed positions by means of one or more cylinders that, as described above, have been secured to the dump truck 10 in one of two locations.

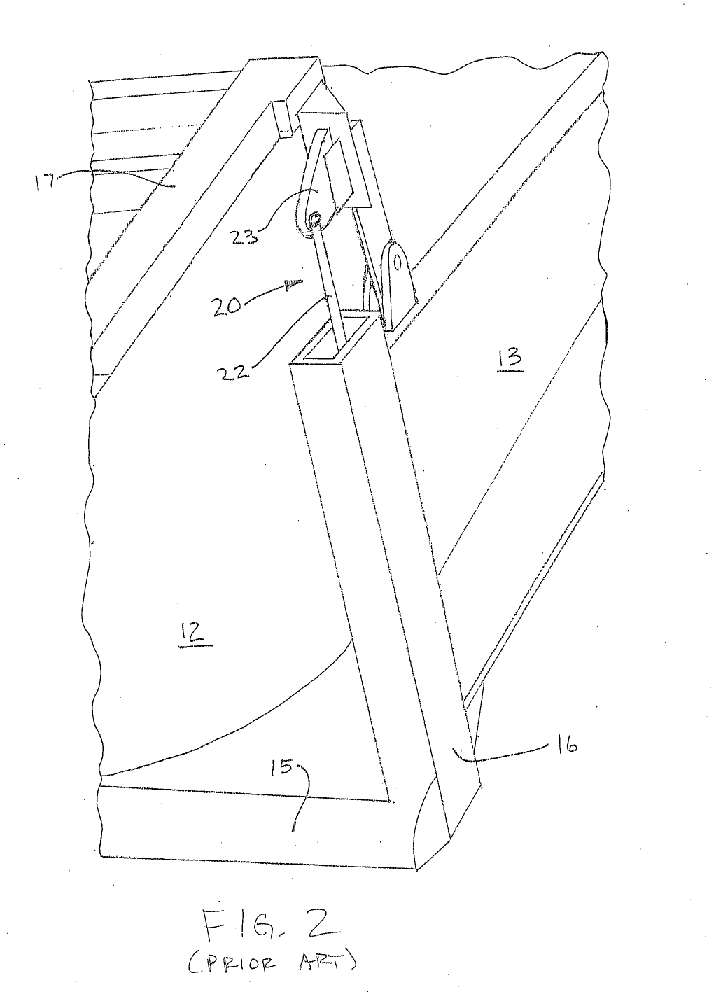

As more clearly shown in FIGS. 2 and 3, a conventional cylinder assembly, indicated generally at 20, is provided in a vertical orientation within each of the hollow rectangular beams of the corner posts 16 of the prior art dump box 11, as described above. As shown therein, each of the conventional cylinder assemblies 20 includes a cylinder 21. The cylinder 21 is conventional in the art and may be embodied as a hydraulically or pneumatically actuated cylinder. The cylinder 21 has a piston rod 22 associated therewith. As is well known in the art, the piston rod 21 can be moved in an axial direction relative to the cylinder in order to extend from or retract within the cylinder 21 as desired. The end of the piston rod 22 is connected through a yoke 23 to the tailgate 17 of the prior art dump box 11. The prior art cylinder 21 has a circular cross sectional shape.

To open the tailgate 17 of the prior art dump box 11, the cylinder assembly 20 is actuated in a conventional manner to extend the piston rod 22 from the cylinder 21. As a result, the tailgate 17 of the prior art dump box 11 is caused to pivot from a closed position to an opened position. To close the tailgate 17 of the dump box 11, the cylinder assembly 20 is actuated in a conventional manner to retract the piston rod 22 within the cylinder 21. As a result, the tailgate 17 of the prior art dump box 11 is caused to pivot from the opened position to the closed position.

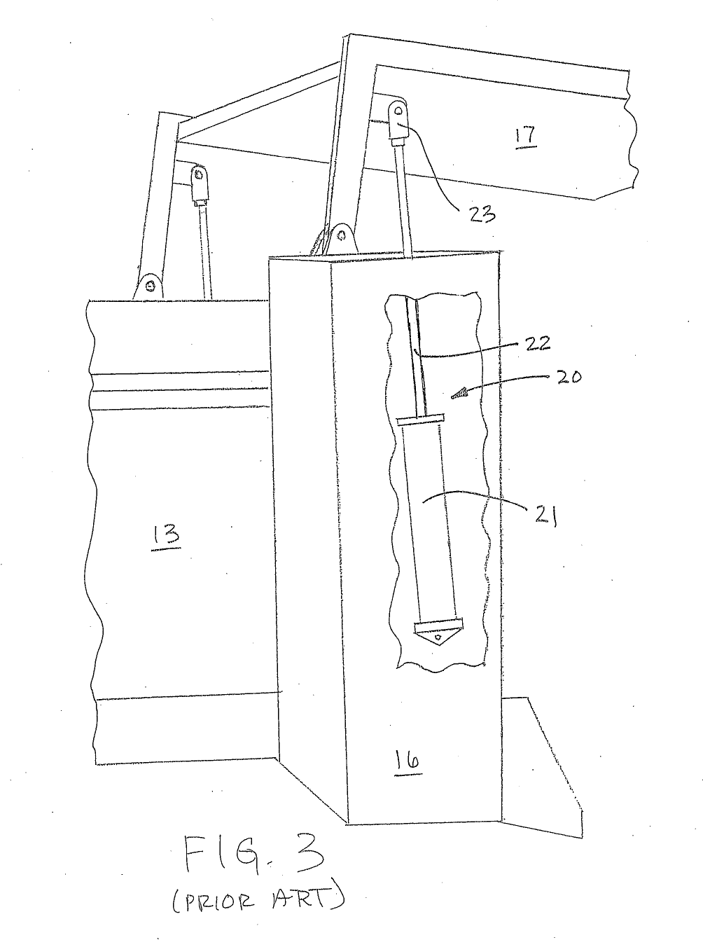

Referring now to FIG. 4, there is illustrated a dump truck, indicated generally at 30, in accordance with a first embodiment of this invention. The dump truck 30 includes a frame supporting a dump box 31 that is pivotable between a lowered position (for storing and transporting items) and a raised position (for dumping the items out of the dump box 31). The dump box 31 includes a floor 32, a pair of side walls 33, a front wall 34, and an open rear end 35. The open rear end 35 of the dump box 31 has a pair of upstanding corner posts 36 that are each formed from a hollow rectangular member. A tailgate 37 is supported on the side walls 33 of the dump box 31 adjacent to the open rear end 35 of the dump box 31 for pivoting movement between a closed position (wherein the tailgate 37 closes the open rear end 35 of the dump box 31) and an opened position (wherein the tailgate 37 is spaced away from the open rear end 35 of the dump box 31, as shown in FIG. 4).

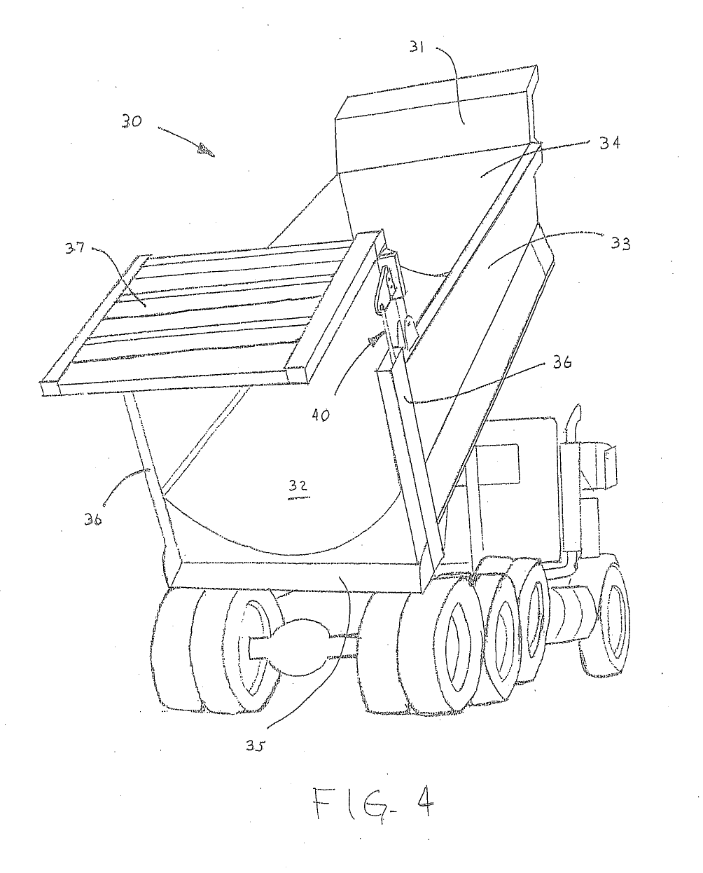

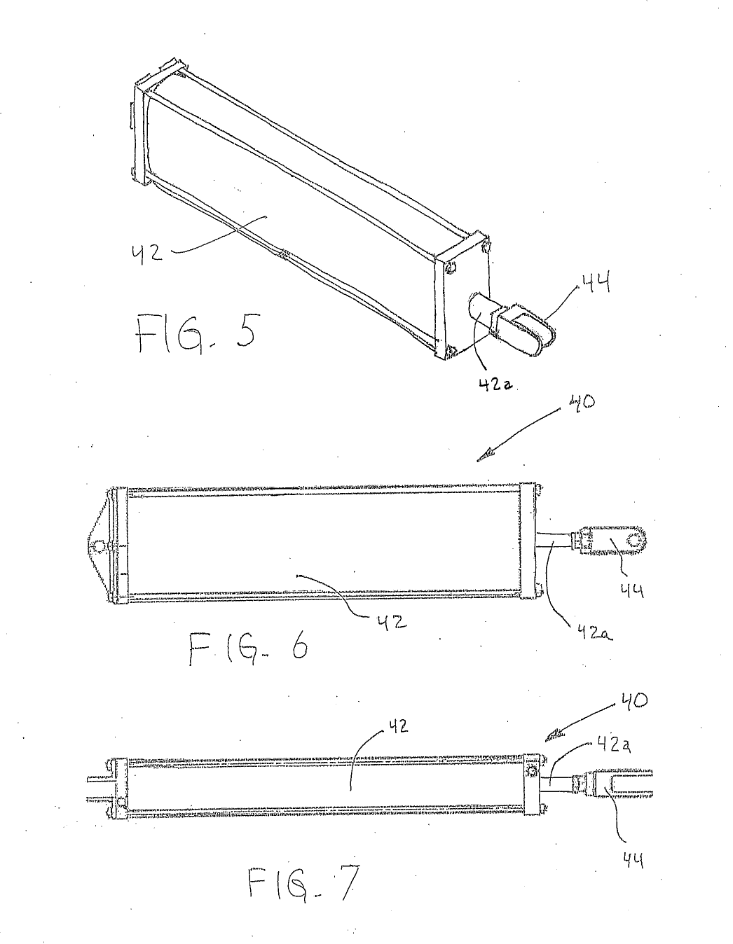

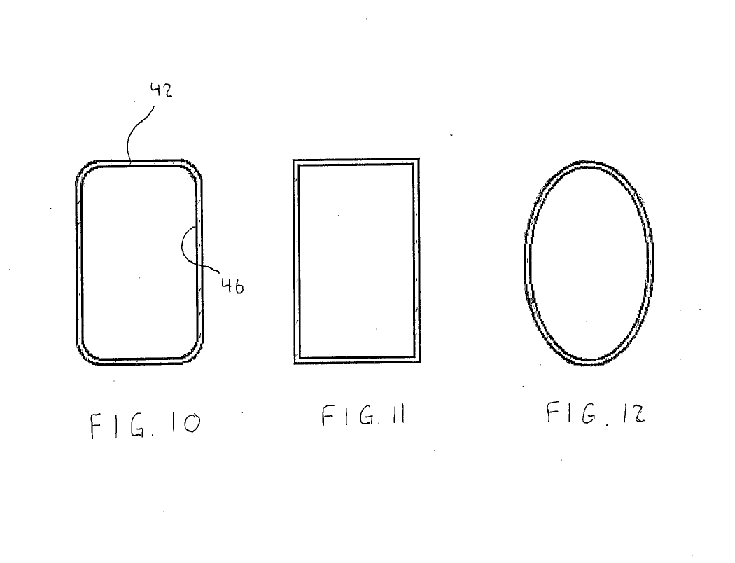

A cylinder assembly, indicated generally at 40, in accordance with this invention is provided within each of the hollow rectangular members of the corner posts 36 of the dump box 31 for moving the tailgate 37 between the opened and closed positions. As will be explained in detail below, each of the cylinder assemblies 40 has a non-circular cross sectional shape. The structure of one of the non-circular cylinder assemblies 40 is illustrated in detail in FIGS. 5 through 10. As shown therein, each of the non-circular cylinder assemblies 40 includes a cylinder 42. The cylinder 42 may be embodied as a hydraulically or pneumatically actuated cylinder. Each cylinder 42 has a respective piston rod 42a associated therewith. As is well known in the art, the piston rod 42a can be extended from or retracted within the associated cylinder 42 as desired. The piston rod 42a is connected to a yoke 44 that is connected to the tailgate 37 of the dump box 31.

To open the tailgate 37 of the dump box 31, the non-circular cylinder assemblies 40 are actuated to extend the piston rods 42a from the respective cylinders 42. As a result, the yoke 44 is similarly extended, causing the tailgate 37 of the dump box 31 to pivot from a closed position to an opened position. To close the tailgate 37 of the dump box 31, the non-circular cylinder assemblies 40 are actuated to retract the piston rods 42a within the respective cylinders 42. As a result, the yoke 44 is similarly retracted, causing the tailgate 37 of the dump box 31 to pivot from the opened position to the closed position.

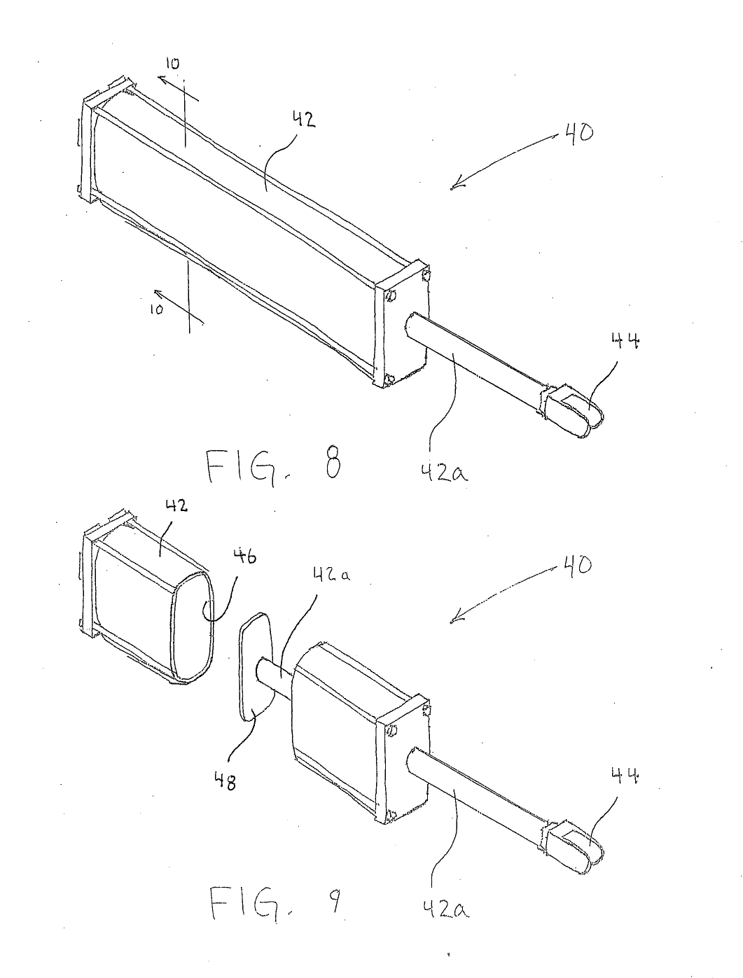

As best shown in FIG. 9, each of the non-circular cylinder assemblies 40 has a cross-sectional shape that is non-circular. The cylinder 42 defines an inner surface 46 that extends in an axial direction. A piston 48 is attached to the piston rod 42a and is able to move in the axial direction relative to the cylinder 42 in a manner that is conventional in the art. The piston 48 has the same cross-sectional shape as the inner surface 46 of the cylinder 42. In the illustrated embodiment, both the inner surface 46 of the cylinder 42 and the piston 48 are formed having oblong cross-sectional shapes, i.e., have cross-sectional shapes that are generally rectangular with rounded corners.

The non-circular shapes allow each of the cylinder assemblies 40 to occupy a larger amount of cross-sectional space within the respective rectangular corner posts 36 than conventional cylinder assemblies 20 having circular cross-sectional shapes would be able to occupy. This is particularly true in the case of the corner post 36 having a rectangular cross-section. The maximum size of a prior art circular cylinder assembly 20 would be limited by the smallest dimension of the rectangular corner post 36, while the non-circular cylinder assembly 40 will occupy more of the interior space of the corner post 36. This allows a relatively larger non-circular cylinder assembly 40 to be installed within the corner post 36, which can provide more force than the prior art circular cylinder assembly 20 for a given size of the corner post 36.

As shown in FIGS. 11 and 12, the non-circular cylinder assembly 40 can be embodied having other cross-sectional shapes. FIG. 11 illustrates the non-circular cylinder assembly 40 as having a rectangular cross-sectional shape, while FIG. 12 illustrates the non-circular cylinder assembly 40 as having an oval cross-sectional shape. This invention contemplates that the non-circular cylinder assembly 40 can have any non-circular cross-sectional shape.

The principle and mode of operation of this invention have been explained and illustrated in its preferred embodiments. However, it must be understood that this invention may be practiced otherwise than as specifically explained and illustrated without departing from its spirit or scope.

What is claimed is:

1. An apparatus comprising:
a dump box having an open end;
a tailgate supported on the dump box for movement between a closed position, wherein the tailgate closes the open rear end of the dump box, and an opened position, wherein the tailgate is spaced away from the open end of the dump box; and
a cylinder assembly that extends between the dump box and the tailgate, the cylinder assembly including a cylinder and a piston that is able to move relative to the cylinder for selectively moving the tailgate between the closed and opened positions, wherein the cylinder assembly has a cross-sectional shape that is non-circular.

2. The apparatus defined in claim 1 wherein the dump box includes a corner post that is formed from a hollow rectangular member, and wherein the non-circular cylinder assembly is disposed within the corner post.

3. The apparatus defined in claim 1 wherein the dump box includes a pair of corner posts that are each formed from a hollow rectangular member, and wherein a non-circular cylinder assembly is disposed within each of the pair of corner posts.

4. The apparatus defined in claim 1 cross-sectional shape of the non-circular cylinder assembly is oblong.

5. The apparatus defined in claim 1 cross-sectional shape of the non-circular cylinder assembly is rectangular.

6. The apparatus defined in claim 1 cross-sectional shape of the non-circular cylinder assembly is oval.

7. The apparatus defined in claim 1 wherein the dump box includes a floor, a pair of side walls, a front wall, and an open rear end, and wherein the cylinder assembly extends between one of the pair of side walls of the dump box and the tailgate.

8. The apparatus defined in claim 1 wherein the dump box includes a floor, a pair of side walls, a front wall, and an open rear end, and wherein a pair of non-circular cylinder assemblies respectively extend between the pair of side walls of the dump box and the tailgate.

9. A vehicle comprising:
a frame;
a dump box supported on the frame and having an open end;
a tailgate supported on the dump box for movement between a closed position, wherein the tailgate closes the open rear end of the dump box, and an opened position, wherein the tailgate is spaced away from the open end of the dump box; and
a cylinder assembly that extends between the dump box and the tailgate, the cylinder assembly including a cylinder and a piston that is able to move relative to the cylinder for selectively moving the tailgate between the closed and opened positions, wherein the cylinder assembly has a cross-sectional shape that is non-circular.

10. The vehicle defined in claim 9 wherein the dump box includes a corner post that is formed from a hollow rectangular member, and wherein the non-circular cylinder assembly is disposed within the corner post.

11. The vehicle defined in claim 9 wherein the dump box includes a pair of corner posts that are each formed from a hollow rectangular member, and wherein a non-circular cylinder assembly is disposed within each of the pair of corner posts.

12. The vehicle defined in claim 9 cross-sectional shape of the non-circular cylinder assembly is oblong.

13. The vehicle defined in claim 9 cross-sectional shape of the non-circular cylinder assembly is rectangular.

14. The vehicle defined in claim 9 cross-sectional shape of the non-circular cylinder assembly is oval.

15. The vehicle defined in claim 9 wherein the dump box includes a floor, a pair of side walls, a front wall, and an open rear end, and wherein the cylinder assembly extends between one of the pair of side walls of the dump box and the tailgate.

16. The vehicle defined in claim 9 wherein the dump box includes a floor, a pair of side walls, a front wall, and an open rear end, and wherein a pair of non-circular cylinder assemblies respectively extend between the pair of side walls of the dump box and the tailgate.
